(19) United States
(12) Patent Application Publication
(10) Pub. No.: US 2008/0014046 A1
(43) Pub. Date: Jan. 17, 2008

(54) Retaining Element for Blocking Screw Elements

(76) Inventor: Robert Bauer, Siget in der Wart (AT)

Correspondence Address: K.F. ROSS P.C., 5683 RIVERDALE AVENUE, SUITE 203 BOX 900, BRONX, NY, 10471-0900, US

(21) Appl. No.: 10/571,049

(22) PCT Filed: Aug. 27, 2004
(86) PCT No.: PCT/EP04/09562

§ 371 Date: Feb. 12, 2007

(30) Foreign Application Priority Data
Sep. 5, 2003 (AT) A 1400/2003

(51) Int. Cl. F16B 39/24

(52) U.S. Cl. 411/164

(57) ABSTRACT

A locking element for holding together threaded parts such as screws and nuts against undesired loosening, consisting of at least two annular lock washers (1, 2) lying on each other and having center holes (14), wherein the inner surfaces lying on each other have teeth (7) and teeth (5) are provided on the outer faces, characterized in that at least one center hole (14) has a rounding (6) or a groove (24) on the inner face provided with teeth.

The present invention relates to a locking element for holding together threaded parts such as screws and nuts against unintended loosening, comprised of at least two interengaging annular lock washers having central holes and confronting inner faces having wedge formations and outer faces each formed with teeth.

Locking elements of different types have been known for a long time.

As shown for example in German 1,129,779, some such screw-locking elements have a spring action. A spring element is compressed by the threaded part and thus brings to bear a certain constant locking force. A disadvantage of this type of screw-locking element is that the material “collapses,” that is with time gives in to the load so that the force it exerts drops. In addition screw-locking elements are known that just increase the friction on the screw head, e.g. toothed washers.

A retaining element that provides good protection against loosening is shown in EP 0,131,556, U.S. Pat. No. 4,583,313, or SE 425,684. It generally comprises two similar interengaging washers whose confronting faces have wedge or saw teeth. They are pressed together when the screw joint is tightened. Rotation of one of the threaded parts turns the respective washer so that the engaging wedge teeth slide on each other and increase the holding force. It is essential for this effect that the pitch of the wedge formation be larger than the pitch of the screwthread of the biggest possible usable screw that can fit through the center hole of the washer. Such retaining elements are called wedge-action lock washers. A problem with these known retaining elements is that there the difference in the amount of friction between the outer faces (high) and the inner faces (low) cannot be accurately determined.

Another disadvantage is encountered with reuse of such retaining elements. The two washers can as described in SE 425,684 be secured together by an adhesive. This connection is undone at initial use, so that the two washers separate and must be fitted together for subsequent use. Another problem caused by reuse is that as a result of the two washers slipping on each other while highly compressed the radial deformed teeth (wedges) wear greatly, which significantly restricts reuse since the teeth need to have a minimum wedge size in order to hold the washers in their end position, corresponding to the minimal thickness and the longest possible length on the wedges.

A further disadvantage of the known retainers is that when used with a new type of screw (DIN EN 24014) the tolerance for the edge radius between the screw head and the screw shaft is larger. Standard washer retainers cut at this edge of their center holes into this fillet area, producing a groove that significantly weakens the screw. If the inside diameter is increased enough to prevent forming this groove, the washers do not center properly.

It is an object of the invention to provide an improved antiloosening system for threaded elements and also to simplify the use and increase the retaining force.

This invention is characterized in that at least one on the washers is provided on an inner periphery of its toothed face with a rounding or offset.

Furthermore the edges of the wedge teeth in one embodiment do not run radially and/or are for example U-, S-, or V-shaped.

The invention is characterized in that the teeth of the toothed face do not extend perfectly radially and/or are curved. A further feature of the invention is that the lock washers are connected to each other by means of a sleeve.

This sleeve is mounted according to the embodiment within the central hole and/or outside the lock washer and has a lip formation that laterally extend over or into the edge of the lock washers. The aforementioned lip formation can be designed annular or annular-segmental. The sleeve can be a slotted ring.

The screw-type locking system according to the invention is furthermore characterized in that the transition between the sleeve and the lip formation is rounded, a chamfer, or a right angle.

Moreover, in every embodiment the lock washer can have a groove for receiving the lip formation in one embodiment according to the invention. According to the invention, all the above-mentioned features that are shown in the drawing can be used alone as well as in any combination of two or more of the features.

In the following the system of this invention is described more closely with reference to the drawing:

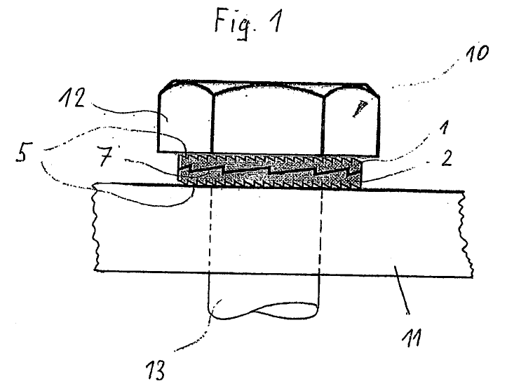

FIG. 1 shows an embodiment of the invention in side view;

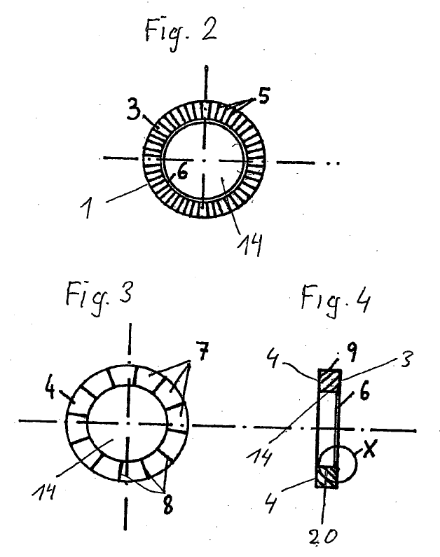

FIG. 2 is an end view of the outer face of a lock washer;

FIG. 3 is an end view of the inner face of a lock washer;

FIG. 4 is a section through the lock washer and detail X is shown in following FIGS. 5a, 5b, 5c, and 5d;

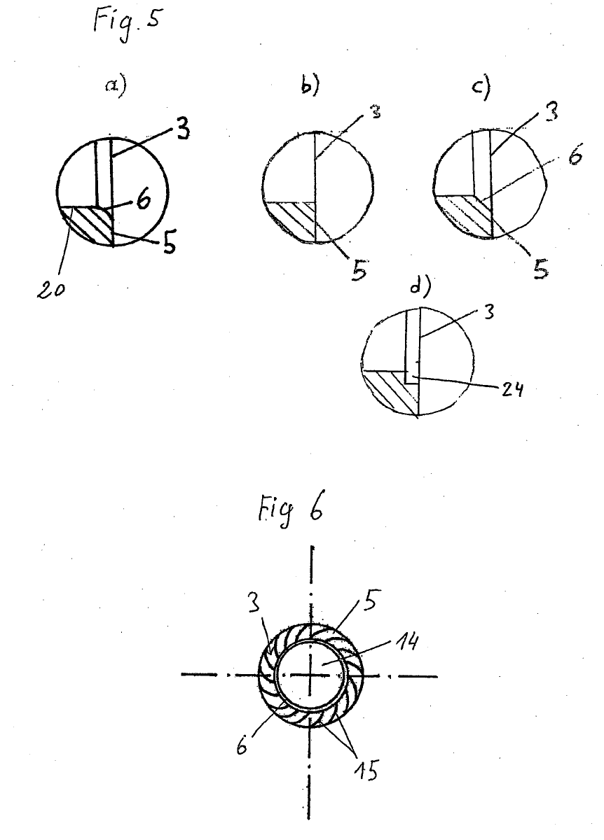

FIG. 6 is an end view of an embodiment with curved teeth;

FIGS. 7 and 8 show the inner faces of a pair of lock washers with V-shaped faces of their teeth;

FIG. 9 shows teeth varying mathematically positively from the radial;

FIG. 10 shows S-shaped teeth;

FIG. 11 shows teeth varying mathematically negatively from the radial;

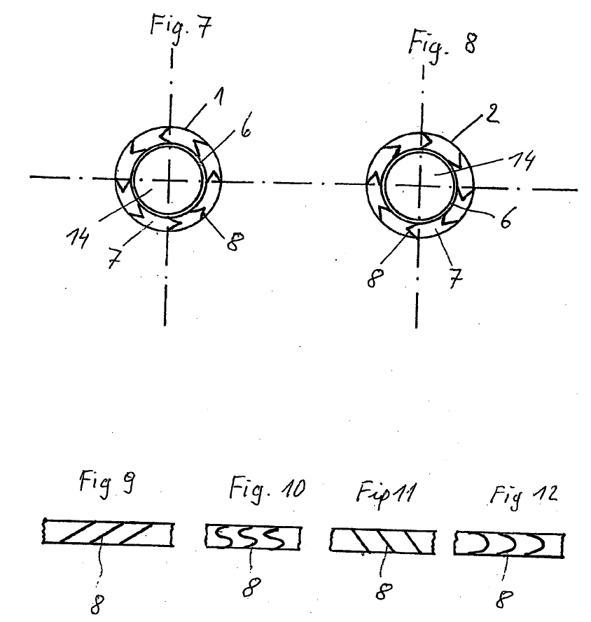

FIG. 12 shows U-shaped teeth;

FIGS. 13 to 16 show several embodiments of lip formations provided on internal sleeves;

FIGS. 17 to 20 show several embodiments of lip formations provided on external sleeves;

FIGS. 21 to 23 are sections through lock-washer sets and side views of respective internal sleeves;

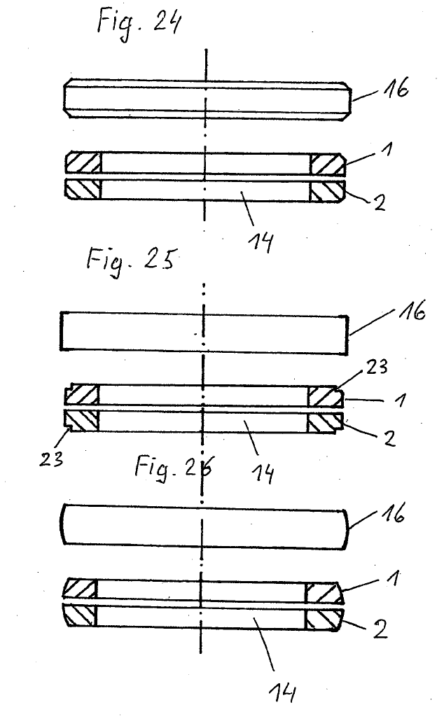

FIGS. 24 to 26 are sections through lock-washer sets and side views of respective external sleeves.

FIG. 1 shows the retaining element according to the invention comprised of an upper washer 1 and a lower washer. 2 that are traversed by a threaded part 10 that has a threaded shaft 13 screwed into a part 11. The retaining element is thus gripped between a screw head 12 and the part 11 and is centered by the screw shaft 13. When the screw 10 is tightened teeth 5 dig into the screw head 12 and into the part 11 and lock to them. As the screw is turned only the upper washer turns with the screw head 12, the lower washer 2 remaining fixed on the part 11. This relative movement is permitted by a sliding of tooth flanks 7 on one another because the thickness increase of the two washer is larger than the movement permitted by the screwthread pitch so that the screw 10 can rotate and the prestressing in the threaded joint rises. In this manner the threaded connection is solidly locked against loosening. The retaining element would work the same with a nut.

FIG. 2 is an end view of an outer face 3 of a washer with the teeth 5 and also shows the rounding 6 or groove 24 (see FIGS. 5a and 5d) according to the invention. This rounding 6 or groove 24 avoids the edge or face of the center hole 14 from cutting into the screw shank 13 where it joints the screw head 12 and thus enables a close guiding and consequently a good centering of the washers.

FIG. 3 shows a top view of the inner face 4 of a washer with the tooth flank 7 and the edges 8 of the tooth flanks.

FIG. 4 shows a section of a washer according to the invention. For simplification, the teeth as well as the tooth flanks are not shown. The sectional area that is limited by a cylindrical outer surface 9, the center hole 14, the inner face 4 and the outer face 3 can be seen. Furthermore, the rounding 6 can be seen that is shown in enlarged view in the section X in FIG. 5a). This rounding of the edge of the center hole 14 at the corner between the outer face 3 and the cylindrical surface of the center hole 14 has the advantage that the screw element 10 is not damaged even if the transition area where the screw shank 13 merges with the screw head 12 is not manufactured accurately or is made with too large a radius. The rounding 6 shown in FIGS. 4 and 5 is designed such that the center hole 14 has an inner face 20 that supports and prevents the thread of the screw element from cutting or digging in. It is however also possible to use a larger radius so that for example the center hole is rounded along its entire height. FIGS. 5b and 5c show the cutout region x with another shape at the edge of the center hole, namely in FIG. 5b as a sharp edge and in FIG. 5c as a 45° bevel. FIG. 5d shows an embodiment with a groove 24 that has the same effect as the rounding 6.

FIG. 6 shows a top view of an embodiment of the outer face 3 of a washer where the edges 15 of the teeth 5 are curved and do not run along radii. This geometrically results in an extension of the teeth and thus mechanically in a better distribution of forces and in decreased wear. The deviation from the radial direction can also be provided independently of the shape of the teeth.

FIGS. 7 and 8 show a top view of the tooth flanks 7 of a lock-washer set in which the edges 8 of the teeth are formed V-shaped. The wedge profile of the upper washer 1 shown in FIG. 7 is the geometric negative of that of the lower washer 2 shown in FIG. 8.

FIGS. 9 to 12 represent in a schematic (and straight) manner further embodiments of the tooth edges 8 of the tooth flanks. The purpose of the different tooth edge shapes is on the one hand an extension of the tooth edges for better pressure distribution as well as a self-centering of the washer that occurs when the washers are distorted against each other.

A lock washer set in which the tooth edges of the tooth flanks 8 do not extend perfectly radially and/or are made U-, S- or V-shaped consists of two non-identical washers. For this embodiment, but also any further embodiments having the same washers, a connection of the sets to achieve an easier or faster mounting is advantageous. The connection however should enable free rotation of the washers so that the connection also works after initial use. This is achieved according to the invention by sleeves 16 or 21 as shown in the subsequent figures. The height of the sleeves is advantageously less than the thickness of the washers when fitted to each other so that it does not work against interfitting of the teeth. On the other hand, the washer and the sleeve have to fit together so that there is sufficient clearance that the sleeve is not damaged when the washers squeezed flatter and wider by external tightening forces (e.g. by means of a screw wrench).

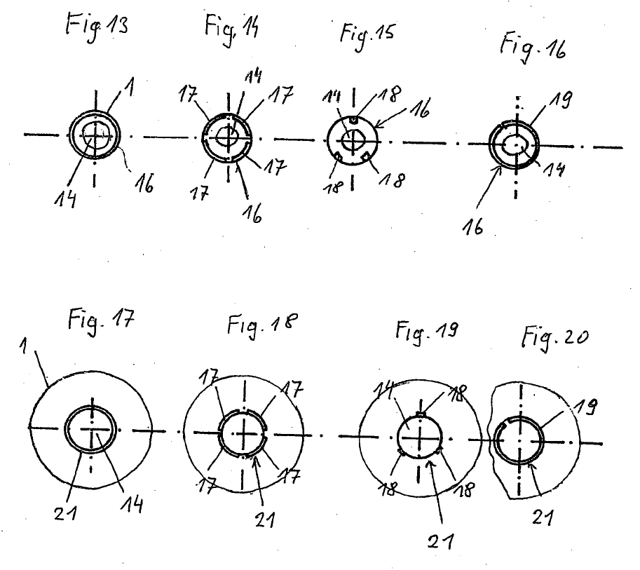

FIGS. 13 to 16 show several examples of sleeves and lip formations as already mentioned before, which are in the present invention provided in the case of a sleeve that is at the outside. This sleeve 16 thus encloses the lock-washer set from the outside. Tabs that extend to the inside project above both flat sides of the lock washer set and thus also prevent separation of the washers even if used more than once. Here, the sleeve in FIG. 13 is designed with an annular lip formation or tab, in FIG. 14 it consists of four segmental tabs 17, in FIG. 15 it is reduced to three tabs 18 and in FIG. 16, it consists of a slotted ring 19, wherein the sleeve consequently is also formed with a slot. The number of annular segments or tabs of course can also be different from the shown number.

FIGS. 17 to 20 also shows several examples of sleeves 21 that however are at the inside and thus in the center hole 14. In analogy to FIGS. 14 to 16, annular segments 17 or lugs 18 or a slotted ring 19 can also be provided here.

The designs with a slotted ring have the advantage that the slotted ring can be easily mounted on the lock washers by compressing or spreading.

FIG. 21 to 23 respectively show a section of a lock washer set as well as a lateral view of the related sleeve that is at the inside with different cross-sectional shapes.

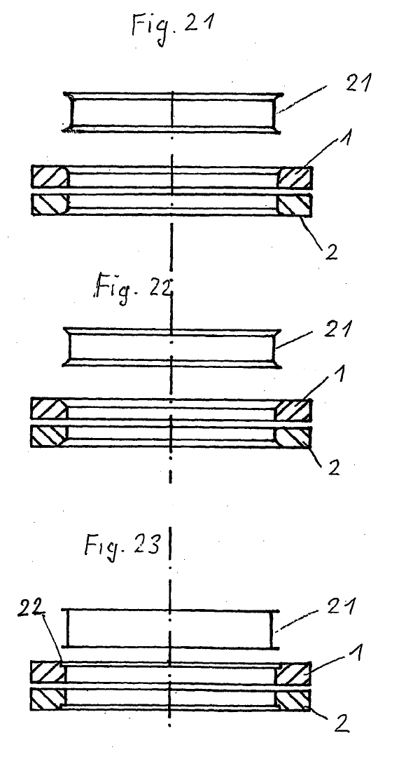

In FIG. 21, the transition between the sleeve 21 and the lip is rounded and in FIG. 22 it is angled. According to FIG. 23, the transition between sleeve and lip is at a right-angle corner the lip engages in a groove 22. All the above-mentioned advantageous features can be provided together or independently of one another. In the designs according to FIGS. 24 to 26, the rounding 6 or groove 24 or beveling can also be provided at the inner edges of the center hole 14. The different designs of the tooth flanks and teeth can be combined with all variants of sleeves.

FIGS. 24 to 26 respectively show a section of a lock washer set as well as a lateral view of the related sleeve that is at the outside in with cross-sections like FIGS. 21 to 23.

1. A locking element for holding together threaded parts such as screws and nuts against undesired loosening, comprising at least two annular lock washers lying on each other and having center holes, wherein the inner surfaces lying on each other have teeth and the outer faces are provided with teeth, characterized in that at least one center hole (14) has a rounding (6) or a groove (24) one the inner face that is provided with teeth.

2. The locking element, possibly according to claim 1, characterized in that the tooth edges (8) of the tooth flanks (7) are oriented off-radial.

3. The locking element according to claim 1, characterized in that the tooth edges (8) of the tooth flanks (7) are V-shaped.

4. The locking element according to claim 1, characterized in that the tooth edges (8) of the tooth flanks (7) are U-shaped.

5. The locking element according to claim 1, characterized in that the tooth edges (8) of the tooth flanks (7) are S-shaped.

6. The locking element, possibly according to claim 1, characterized in that the edges of the teeth (5) have a non-radial direction.

7. The locking element according to claim 1, characterized in that the edges of the teeth (5) have a curvature.

8. The locking element, possibly according to claim 1, characterized in that the lock washers (1, 2) are connected to each other by means of a sleeve (16, 21).

9. The locking element according to claim 8, characterized in that the sleeve (21) is disposed on inner faces of the center holes (14).

10. The locking element according to claim 8, characterized in that the sleeve (16) is disposed on outer faces of the lock washers (1, 2).

11. The locking element according to claim 1, characterized in that one sleeve is disposed on the inner faces of the center holes (14) and that a further sleeve is disposed on the outer faces of the lock washers.

12. The locking element according to claim 8, characterized in that the sleeve (16, 21) has a lip that laterally extends over or into an edge of the lock washers (1, 2).

13. The locking element according to claim 12, characterized in that the lip is annular.

14. The locking element according to claim 12, characterized in that the lip is formed by tabs (18).

15. The locking element according to claim 12, characterized in that the tabs are annular segments (17).

16. The locking element according to claim 8, characterized in that the sleeve is a slotted ring.

17. The locking element according to claim 12, characterized in that a transition between the sleeve (16, 21) and the lip has a rounding and/or a chamfer.

18. The locking element according to claim 12, characterized in that a transition between the sleeve and the lip is designed perpendicular.

19. The locking element according to claim 12, characterized in that the lock washers have a groove (22, 23) for receiving the lip.
